(19) United States
(12) Patent Application Publication
(10) Pub. No.: US 2026/0296453 A1
(43) Pub. Date: Oct. 1, 2026

(54) APPARATUS AND METHODS FOR IMPROVED ROAD AGENT BEHAVIOR PREDICTION USING MULTI-TASK LEARNING

(71) Applicant: AVRIDE Inc., Newburyport, MA (US)

(72) Inventors: Andrei Volchek, Tel Aviv (IL); Roman Udovichenko, Austin, TX (US)

(21) Appl. No.: 19/577,639

(22) Filed: Mar. 25, 2026

Related U.S. Application Data
(60) Provisional application No. 63/777,178, filed on Mar. 25, 2025.

(51) Int. Cl. B60W 50/00; B60W 60/00; G06N 20/00

(52) U.S. Cl. CPC B60W 50/0097; B60W 60/001; G06N 20/00; B60W 2050/0031; B60W 2554/802

(57) ABSTRACT

Provided herein is an apparatus and method for improved road agent behavior prediction using multi-task learning, the apparatus including: at least one processor; and a memory, the memory contains instructions configuring the at least one processor to: receive, from one or more vehicles, a real-world road data, wherein the real-world data has been collected using at least in part a data acquisition system of the one or more vehicles; generate, from the real-world data, a ground-truth dataset including ground-truth trajectories, ground-truth intents, and calculated feature values; and train, using the ground-truth dataset, a multi-task machine learning model.

### CROSS-REFERENCE TO RELATED APPLICATIONS

This application claims the benefit of priority to U.S. Provisional Application No. 63/777,178, filed on Mar. 25, 2025, and entitled “METHOD FOR ENHANCING ROAD AGENT BEHAVIOR PREDICTION THROUGH AUXILIARY FEATURE TRAINING IN MACHINE LEARNING MODELS FOR AUTONOMOUS VEHICLES,” which is incorporated in its entirety herein by reference.

### FIELD OF THE INVENTION

The present invention is directed generally to methods of training and using machine-learning models and, more particularly, to apparatus and methods for improved road agent behavior prediction using multi-task learning.

### BACKGROUND OF THE INVENTION

Historically, machine-learning models for autonomous vehicles are may be used to predict behaviors in autonomous vehicles. However, the approaches employed historically have failed to provide an improvement of accuracy which evidences a disadvantage in that these learning models. Therefore, the need exists for an improved machine learning model that improves on the accuracy of the machine-learning models. The present disclosure meets that need.

### SUMMARY

In some aspects, the techniques described herein relate to an apparatus for improved road agent behavior prediction using multi-task learning, the apparatus including: at least one processor; and a memory, wherein the memory is communicatively connected to the at least one processor, the memory contains instructions configuring the at least one processor to: receive, from one or more vehicles, a real-world road data, wherein the real-world data has been collected using at least in part a data acquisition system of the one or more vehicles; generate, from the real-world data, a ground-truth dataset including ground-truth trajectories, ground-truth intents, and calculated feature values; and train, using the ground-truth dataset, a multi-task machine learning model, wherein training the multi-task machine learning model includes: generating, using the real-world data, a plurality of trajectory predictions using a trajectory model; generating, using the real-world data, a plurality of intent predictions using an intent model; and generating, using the real-world data, a plurality of auxiliary feature predictions using an auxiliary feature model; and training multi-task machine-learning model using a multi-task loss function, wherein the multi-task loss function is a function of a comparison between the plurality of trajectory predictions and the ground-truth trajectories, a comparison between the plurality of intent predictions and the ground-truth intents, and a comparison between the plurality of auxiliary feature predictions and the calculated feature values.

In some aspects, the techniques described herein relate to an method for improved road agent behavior prediction using multi-task learning, the method including: receiving, using at least one processor and from one or more vehicles, a real-world road data, wherein the real-world data has been collected using at least in part a data acquisition system of the one or more vehicles; generating, using the at least one processor and from the real-world data, a ground-truth dataset including ground-truth trajectories, ground-truth intents, and calculated feature values; and training, using the at least one processor and the ground-truth dataset, a multi-task machine learning model, wherein training the multi-task machine learning model includes: generating, using the real-world data, a plurality of trajectory predictions using a trajectory model; generating, using the real-world data, a plurality of intent predictions using an intent model; and generating, using the real-world data, a plurality of auxiliary feature predictions using an auxiliary feature model; and training multi-task machine-learning model using a multi-task loss function, wherein the multi-task loss function is a function of a comparison between the plurality of trajectory predictions and the ground-truth trajectories, a comparison between the plurality of intent predictions and the ground-truth intents, and a comparison between the plurality of auxiliary feature predictions and the calculated feature values.

### BRIEF DESCRIPTION OF THE DRAWINGS

For a more full understanding of the nature and desired objects of the present invention, reference is made to the following detailed description taken in conjunction with the accompanying drawing figures wherein like reference characters denote corresponding parts throughout the several views.

FIGS. 1A-1D show exemplary embodiments of apparatus for improved road agent behavior prediction using multi-task learning;

FIGS. 2A-2C show exemplary views of vehicles;

FIGS. 3A-3B show an exemplary vehicle computing architecture;

FIG. 4 shows an exemplary machine learning module;

FIG. 5 shows an exemplary neural network;

FIG. 6 shows an exemplary method for improved road agent behavior prediction using multi-task learning; and

FIG. 7 shows an exemplary computing device.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

A “vehicle,” for the purposes of this disclosure is a device that is designed to transport goods, people, and/or animals.

A “trajectory,” for the purposes of this disclosure, is the path that a vehicle takes over a period of time.

An “intent,” for the purposes of this disclosure, is a short term behavioral goal of an agent, vehicle, or user. An intent, in some embodiments, may include a combination of behavior of an agent and ego vehicle. As a non-limiting example, an intent may include, for an agent, “this agent will yield to ego vehicle and ego vehicle should go first on uncontrolled intersection.”

A “feature value,” for the purposes of this disclosure, is a measurement with respect to a feature in the real-world.

A “world representation,” for the purposes of this disclosure, is a data structure that represents an agent’s understanding of its world. An agent, in this instance. may include a vehicle, fleet of vehicles, user, of the like, as examples.

A “loss function,” for the purposes of this disclosure, is a function that quantifies the accuracy or correctness of a machine-learning model.

A “multi-task loss function,” for the purposes of this disclosure, is a loss function that is used to train multiple heads of a machine-learning model together, wherein the multi-task loss function includes a loss from a plurality of tasks.

For the purposes of this disclosure, a “deployment dataset” is a set of data that a machine-learning model is exposed to after it has completed training.

### Detailed Description

Provided herein is a multi-task learning approach that enhances predication accuracy, improves model generalization, and reduces computational requirements for deployment in autonomous vehicles. The present invention is directed to a method for improving machine learning models through auxiliary feature training. Furthermore, the present invention includes a method for predicting the intentions and behaviors of other road agents in autonomous driving scenarios. The present invention solves problems experienced with the prior art because it provides an improved machine learning model that uses a multi-task learning approach that enhances predication accuracy, improves model generalization, and reduces computational requirements for deployment in autonomous vehicles. Those and other advantages and benefits of the present invention will become apparent from the detailed description of the invention hereinbelow.

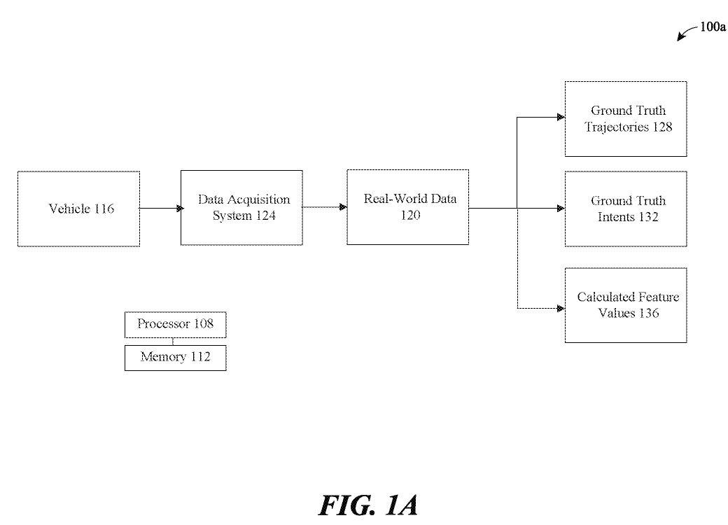

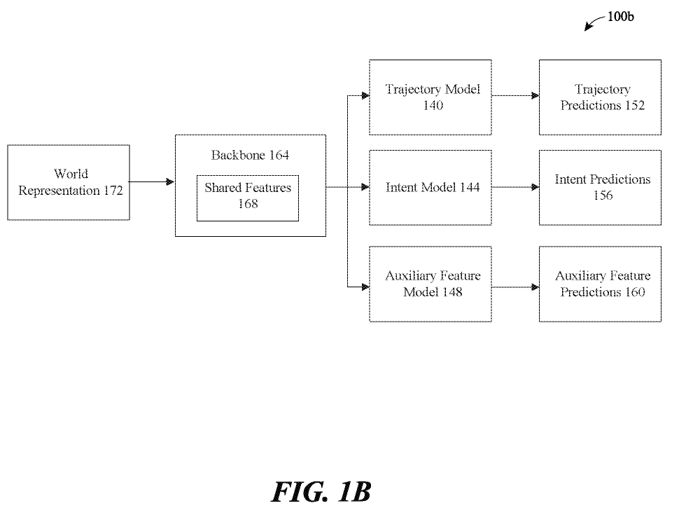

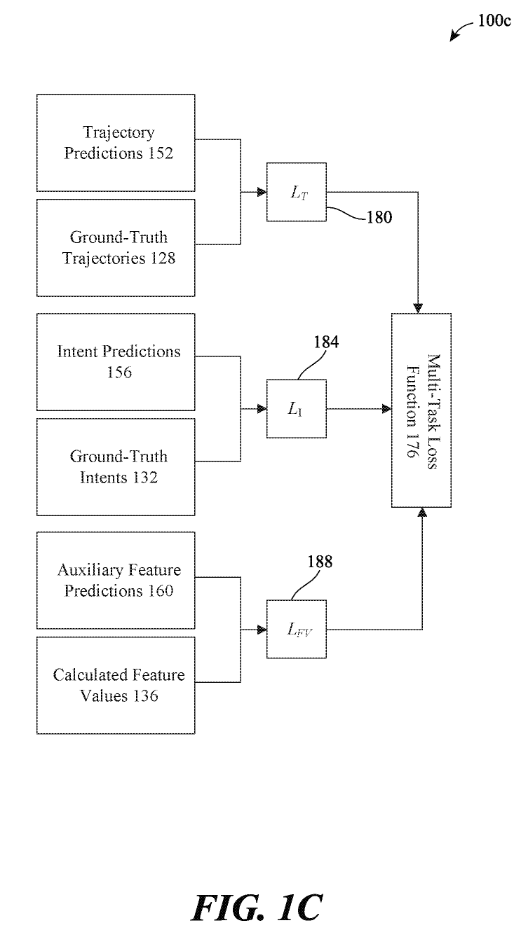

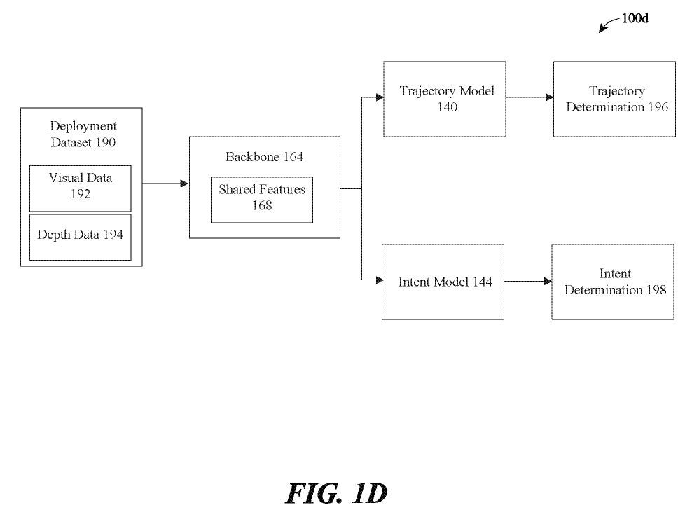

Referring now to FIGS. 1A-1D, an exemplary embodiment of apparatus 100a for improved road agent behavior prediction using multi-task learning is illustrated. Apparatus 100a may include circuitry such as without limitation a processor communicatively connected to a memory; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIGS. 1A-1D, apparatus 100a may be designed and/or configured to perform any method, method step, or sequence of method steps in any embodiment described in this disclosure, in any order and with any degree of repetition. For instance, apparatus 100a may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. apparatus 100a may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIGS. 1A-1D, in some embodiments, apparatus 100a, 100b, 100c, and 100d may represents different embodiments of the same apparatus. In some embodiments, each of 100a, 100b, 100c, and 100d may be configured to perform the functions of any of the other apparatus.

### Generation of Training Data

With continued reference to FIGS. 1A-1D, memory 112 may include instructions configuring processor 108 to memory 112 may include instructions configuring processor 108 to receive, from one or more vehicles 116, real-world road data 120, wherein the real-world data 120 has been collected using at least in part a data acquisition system 124 of the one or more vehicles 116.

With continued reference to FIGS. 1A-1D, in some embodiments, vehicle 116 may be motorized. As non-limiting examples, vehicle 116 may include a car, a scooter, an ebike, an ATV, a motorcycle, a motorbike, a minibike, a truck, a golf cart, an aircraft, and the like. In some embodiments, vehicle 116 may be human-powered. As non-limiting examples, vehicle 116 may include a bike, a rickshaw, a skateboard, a scooter, or the like.

With continued reference to FIGS. 1A-1D, data acquisition system 124 may include one or more sensors, a sensor, a sensor suite, or a sensor array. In some embodiments, data acquisition system 124 may include, as non-limiting examples, LIDAR, RADAR, ultrasonic sensors, cameras, microphones, light sensors, and the like.

With continued reference to FIGS. 1A-1D, a light detection and ranging (LIDAR) system is a system that uses lasers to measure distances as a function of measuring reflected light. In some embodiments, LIDAR system may include a light amplification by stimulated emission of radiation component (i.e., a laser). A “laser component,” for the purposes of this disclosure, is a device that emits a laser beam through a process of optical amplification based on the stimulated emission of electromagnetic radiation. A “laser beam,” for the purposes of this disclosure, is a stream of light that is emitted from a laser component.

With continued reference to FIGS. 1A-1D, LIDAR systems may emit laser beams and detect when they reflect back to the LIDAR system in the form of returning beams of light. LIDAR system may include a light sensor. Light sensor may be configured to detect returning beams of light. Light sensor may be configured to both detect light and the time at which light is detected. In some embodiments, light sensor may include a photodiode. A photodiode is a semiconductor diode sensitive to photon radiation, such as visible light, infrared or ultraviolet radiation, X-rays and gamma rays. Photodiode may produce an electrical current when it absorbs photons. Photodiode may include a PIN structure or p–n junction. As a non-limiting example, when a photon of sufficient energy strikes the diode, it creates an electron–hole pair. This mechanism is also known as the inner photoelectric effect. If the absorption occurs in the junction's depletion region, or one diffusion length away from it, these carriers may be swept from the junction by the built-in electric field of the depletion region. Thus, in examples, holes move toward the anode, and electrons toward the cathode, and a photocurrent is produced. The total current through the photodiode may be the sum of the dark current (current that is passed in the absence of light) and the photocurrent. Dark current may be minimized to maximize the sensitivity of the device.

With continued reference to FIGS. 1A-1D, in some embodiments, a processor may be communicatively connected to light sensor and configured to receive light detection data from light sensor. Light detection data may include, as non-limiting examples, intensity data and/or temporal data. Temporal data may include a time (or times) at which light is detected. In some embodiments, a processor may be configured to determine a distance metric as a function of the light detection data. For example, if an object is farther away from a LIDAR system light emitted from LIDAR system will take longer to reflect back and be detected by light sensor; thus, it can be inferred that the object that reflected the light is further away. Conversely, if an object is closer to a LIDAR system light emitted from LIDAR system will take a shorter amount of time to reflect back and be detected by light sensor; thus, it can be inferred that the object that reflected the light is closer.

With continued reference to FIGS. 1A-1D, in some embodiments, data acquisition system 124 may include a camera array. Camera array may include a plurality of cameras stationed at different points around vehicle 116. In some embodiments, camera array may be arranged in a circular pattern. In some embodiments, camera array may be arranged in a circular pattern such that the fields of view of the cameras have full 360 degree coverage. In some embodiments, the spacing of the cameras may be dependent on the camera’s field of view; for example if the cameras have a lower field of view, then more cameras may be needed to achieve the requisite coverage.

With continued reference to FIGS. 1A-1D, memory 112 may include instructions configuring processor 108 to generate, from the real-world data 120, a ground-truth dataset comprising ground-truth trajectories 128, ground-truth intents 132, and/or calculated feature values 136.

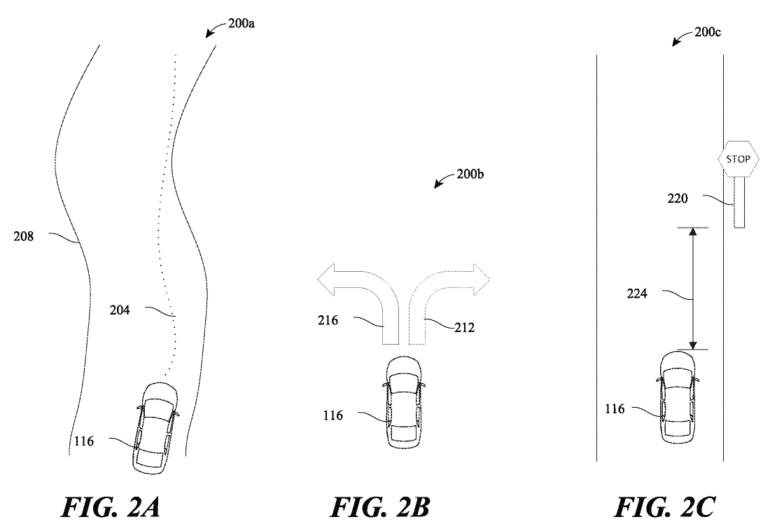

Referring now to FIG. 2A, an exemplary view of 200a a vehicle is shown. Trajectory 204 shows the path of Vehicle 116 through the world. Vehicle 116 may or may not be driving on a path, such as road 208. In some embodiments, trajectory 204 may be disposed on road 208. Trajectory 204 may include turns, swerves, lane changes, and the like.

Referring back to FIGS. 1A-1D, generating, from the real-world data 120, the ground-truth trajectories 128 may include tacking a location of an agent through a temporal period to determine a ground-truth trajectory 128 associated with the agent. Real-world data 120 may include data previously collected by data acquisition systems 124. Therefore the ground-truth trajectory 128 and/or ground-truth intents 132 represent the movement or actions of actual vehicles. For example, tacking a location of an agent through a temporal period may include determining a location of an agent at a first temporal point and determining the location of the agent at a second temporal point. In some embodiments, this may include determining a location of an agent at regularly spaced temporal points.

With continued reference to FIGS. 1A-1D, generating, from the real-world data 120, ground-truth intents 132, may include determining an action for an agent. As non-limiting examples, intents may include, intent to turn, intent to step, intent to merge, intent to change lanes, intent to park, intent to pull over, intent to slow down, intent to speed up, and the like.

Referring now to FIG. 2B, an exemplary view of 200b a vehicle is shown. A set of intents 212 are shown to represent a plurality of intents that vehicle 116 and/or a driver of vehicle 116 may have. In some embodiments, 216 may represent a chosen or predicted intent. Ground-truth intents 132 may be generated from real-world data 120 be identifying the intents of vehicle 116 by looking at future data of vehicle 116.

With continued reference to FIGS. 1A-1D, calculating, from the real-world data 120, calculated feature values 136. In some embodiments, calculating calculated feature values 136 may include identifying an auxiliary feature in the real-world data 120, wherein the auxiliary feature corresponds with a real-world object. Auxiliary feature may include features, other than other agents, vehicles, or the like, that impacts the decision making or performance of an autonomous vehicle. Auxiliary features may include, as non-limiting examples, signs, stop signs, school buses, emergency vehicles, construction signs or equipment, pedestrians, cross walks, traffic lights, cones, road markings, center lines, lane separators, medians, pot holes, obstacles, curbs, bike lanes, and the like. In some embodiments, calculating calculated feature values 136 may include calculating a distance between the auxiliary feature and an agent. For example, this may include determining a distance from vehicle 116 to a cross walk, to the curb, or the like. In some embodiments, this process may include using machine vision and/or object classification algorithms to identify auxiliary feature. In some embodiments, mathematical algorithms may be used to extract the distance from camera data. In some embodiments, the distance data may be retrieved from LIDAR, RADAR, or ultrasonic data that is collected by the agent (e.g., vehicle 116).

Referring now to FIG. 2C, another exemplary view 200c of a vehicle is shown auxiliary feature 220 is shown. In FIG. 2C, auxiliary feature 220 is depicted as a stop sign; however, that is for illustrative purposes only. In some embodiments, auxiliary feature 220 may be identified within real-world data 120. Then, a distance 2from vehicle 116 to auxiliary feature 220 may be calculated as described throughout this disclosure.

Referring back to FIGS. 1A-1D, in some embodiments, the generation of the ground truth data set may allow for easier and cheaper training of downstream machine-learning models. This is the case at least because there is no need for the manual labeling of training data as the ground truth data can be extracted from real-world data 120.

### Training of Machine-Learning Model

With continued reference to FIGS. 1A-1D, memory 112 may include instructions configuring processor 108 to train, using the ground-truth dataset, a multi-task machine learning model. For example, multi-task machine-learning model may include a machine-learning model with multiple heads. For example, each head of the machine-learning model may be configured to perform a specific action. In some embodiments, multi-task machine-learning model may include, a trajectory model 140, an intent model 144, and/or an auxiliary feature model 148. In some embodiments, trajectory model 140, intent model 144, and auxiliary feature model 148 may be different heads of the multi-task machine learning model.

With continued reference to FIGS. 1A-1D, multi-task machine-learning model may be configured to operate as a prediction model. Multi-task machine-learning model may include a neural network. Multi-task machine-learning model may be configured to take as input world representation data (world representation 172) (e.g., as non-limiting examples, data about agents around us, HD map, state of traffic lights, etc). For each agent (e.g., a vehicle) it may output predictions of the agent’s future actions. As a non-limiting example, this may include where will it be in 1, 3, or 5 seconds. Training data for multi-task machine-learning model may include data from previous rides. Each training sample may include the World representation 172 at some moment X, and the ground truth for training data (e.g., ground-truth trajectory 128 and/or ground-truth intents 132) may be predicted agent positions or intents from the future (>X). So, in this manner, data labeling may be avoided, which increases available training data and decreases cost.

With continued reference to FIGS. 1A-1D, in some embodiments, each head of the multi-task machine learning model may be trained together. For example, trajectory model 140, intent model 144, and auxiliary feature model 148 may be trained together. Training the heads together may include optimizing each head using a common loss function, wherein the common loss function is a function of a loss of each model. For example, trajectory model 140, intent model 144, and auxiliary feature model 148 may be trained together using the same loss function. By training the trajectory model 140 and the intent model 144 together with an auxiliary feature model 148, the performance of the trajectory model 140 and the intent model 144 is improved over training just the trajectory model 140 and the intent model 144 together (or training each individually). This represents a clear technical improvement to the training of a neural network.

With continued reference to FIGS. 1A-1D, training multi-task machine-learning model on an auxiliary feature task has been found to increase accuracy of the trajectory prediction task. Auxiliary tasks may include, as a non-limiting example: for each agent, output a distance from its current position to the closest curb, solid line, crosswalk, etc. from an HD map. Auxiliary tasks may include, as a non-limiting example: for lanes in the map, output a number of co-directional lanes to the left and to the right from that lane. Introduction of these tasks may force neural network to learn better representations of objects on the scene (e.g of map elements.) These better representations of objects are beneficial for "trajectory prediction" task.

With continued reference to FIGS. 1A-1D, training the multi-task machine-learning model may include generating, using real-world data 120, a plurality of trajectory predictions 152, using trajectory model 140. For example, a real-world data 120 may be fed into trajectory model 140 and trajectory model 140 may generate plurality of trajectory predictions 152. In some embodiments, a backbone 164 may be used to extract features from real-world data 120. In some embodiments, features may be shared features 168 that are used each head of the multi-task machine-learning model. Backbone 164 may be a shared feature-extraction backbone that is used by each head of the multi-task machine learning model. Backbone 164 may include a feature extractor; feature extractor may include a convolutional neural network (CNN), deep neural network (DNN), a vision transformer (ViT), resnet, multimodal feature extractors, transformer blocks, attention layers, or the like. In some embodiments, backbone 164 may include a plurality of transformer blocks. In some embodiments, backbone 164 may extract features (e.g., features may be shared features 168) from real-world data 120 and features may be fed to trajectory model 140 as input.

With continued reference to FIGS. 1A-1D, training the multi-task machine-learning model may include generating, using the real-world data 120, a plurality of intent predictions 156 using an intent model 144. For example, a real-world data 120 may be fed into intent model 144 and intent model 144 may generate plurality of intent predictions 156. In some embodiments, backbone 164 may extract features (e.g., features may be shared features 168) from real-world data 120 and features may be fed to intent model 144 as input.

With continued reference to FIGS. 1A-1D, training the multi-task machine-learning model may include generating, using the real-world data 120, a plurality of auxiliary feature predictions 160 using an auxiliary feature model 148. For example, a real-world data 120 may be fed into auxiliary feature model 148 and auxiliary feature model 148 may generate plurality of auxiliary feature predictions 160. In some embodiments, backbone 164 may extract features (e.g., features may be shared features 168) from real-world data 120 and features may be fed to auxiliary feature model 148 as input.

With continued reference to FIGS. 1A-1D, apparatus 100b may include a world representation 172. World representation 172 may include encodings of objects (e.g., vehicles, agents, auxiliary features, and pedestrians), properties (e.g., position, speed, velocity acceleration, distance, and direction), relationships, hidden variables (e.g., latent state), and the like. World representation 172 may be constructed from real-world data 120. In some embodiments, world representation 172 may include or be constructed from fused data from sensors (as a non-limiting example, camera pictures may be “overlayed” with depth data from LIDAR using, as a non-limiting example, machine vision or feature recognition). In some embodiments, trajectory model 140, intent model 144, auxiliary feature model 148, and backbone 164 may receive real-world data 120 through world representation 172. In some embodiments, world representation 172 may include an HD map. HD map may include individual lanes, markings like solid lines, information about which traffic light "controls" which lanes, and the like.

With continued reference to FIGS. 1A-1D, apparatus 100c may be configured to train the multi-task machine-learning model. Training the multi-task machine-learning model may include training multi-task machine-learning model using a multi-task loss function 176. In some embodiments, training multi-task machine-learning model may include determining a loss for each task of multi-task machine-learning model and combining the losses in a multi-task loss function 176 to train the multi-task machine-learning model. In some embodiments, training multi-task machine learning model may include comparing a trajectory prediction 152 to ground-truth trajectory 128; this may include finding a difference between a trajectory prediction 152 and ground-truth trajectory 128. In some embodiments, training multi-task machine learning model may include comparing an intent prediction 156 to ground-truth intent 132; this may include finding a difference between an intent prediction 156 and ground-truth intent 132. In some embodiments, training multi-task machine learning model may include comparing an auxiliary feature prediction 160 to calculated feature value 136; this may include finding a difference between an auxiliary feature prediction 160 and calculated feature value 136. In some embodiments, multi-task loss function 176 may be a function of a trajectory loss 180, intent loss 184, and auxiliary feature loss 188. Trajectory loss 180 may include a difference between trajectory prediction 152 and ground-truth trajectory 128. Intent loss 184 may include a difference between intent prediction 156 and ground-truth intent 132. Auxiliary feature loss 188 may include a different between auxiliary feature prediction 160 and a calculated feature value 136.

With continued reference to FIGS. 1A-1D, the multi-task learning approach described herein provides several technical benefits. For example, the multi-task approach enhances prediction accuracy. Multi-task models wherein just the trajectory model and intent model are trained together exhibit lower than when the trajectory model 140, intent model 144, and auxiliary feature model 148 are trained together. This is despite the fact that the auxiliary feature model 148 may be decoupled from the other two heads and not actually used during deployment. Additionally, this approach improved model generalization and reduces the computational requirements (this may be particularly useful in the case of autonomous vehicles, wherein local computing power may be subject to constraints).

### Deployment

With continued reference to FIGS. 1A-1D, apparatus 100d may operate a deployed version of multi-task machine learning model. For example, multi-task machine-learning model may be deemed to be deployed when it is exposed to real-world data that does not have associated ground-truth data. In some embodiments, memory 112 may include instructions configuring processor 108 to decouple the auxiliary feature model 148 from the multi-task machine learning model after the multi-task machine learning model has been trained. This may be in accordance with the improvements described above. For example, the auxiliary feature model 148 may be trained with trajectory model 140 and intent model 144 to improve the accuracy of trajectory model 140 and intent model 144, but then decoupled (e.g., to save computing resources) when the model is deployed.

With continued reference to FIGS. 1A-1D, memory 112 may include instructions configuring processor 108 to receive a deployment dataset 190 from a data acquisition system 124 of the one or more vehicles 116. Deployment dataset 190 may include any data described to be collected by data acquisition system 124. As non-limiting examples, deployment dataset 190 may include microphone data, camera data, ultrasonic data, LIDAR data, RADAR data, temperature data, and the like. Deployment dataset 190 may include data that is collected from live vehicles 116 that require the outputs of multi-task machine-learning model in order to autonomously navigate. In some embodiments, multi-task machine-learning model may be configured to run on a computing system that is local to vehicle 116. In some embodiments, multi-task machine-learning model may be configured to run on a computing system that is remote to vehicle 116. In some embodiments, deployment dataset 190 may include visual data 192. Visual data may include, as non-limiting examples, pictures, video, or the like. In some embodiments, deployment dataset 190 may include depth data 194. Depth data 194 is data that describes a distance of an object from point in space. For example, depth data 194 may include LIDAR data, RADAR data, ultrasonic data, or the like.

With continued reference to FIGS. 1A-1D, memory 112 may include instructions configuring processor 108 to extract a plurality of features (e.g., shared features 168), from the deployment dataset 90, into a shared feature space using a feature-extraction backbone (e.g., backbone 164). This may be further described throughout this disclosure.

With continued reference to FIGS. 1A-1D, memory 112 may include instructions configuring processor 108 to determine a trajectory determination 196 from the plurality of extracted features using the trained trajectory model 140. In some embodiments, this may include receiving one or more features from backbone 164 and outputting a trajectory determination 196. Memory 112 may include instructions configuring processor 108 to determine an intent determination 198 from the plurality of extracted features using the trained intent model 144. In some embodiments, this may include receiving one or more features from backbone 164 and outputting a intent determination 198. In some embodiment, auxiliary feature determination can be made using, as non-limiting examples, camera data, LIDAR data, and/or fused camera and LIDAR data, without the need to use the multi-task machine-learning model

### Exemplary Vehicle Computing Architecture

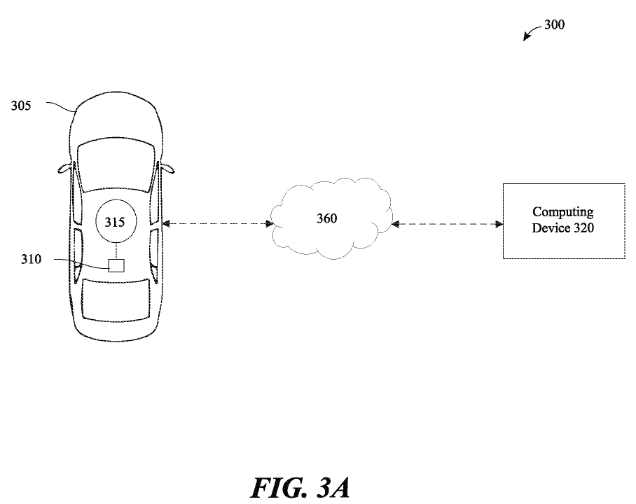

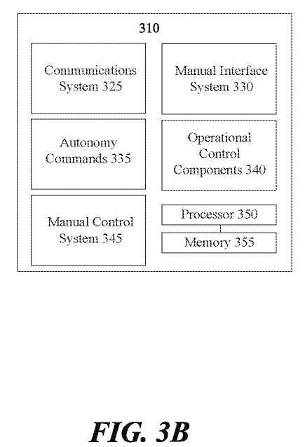

Referring now to FIGS. 3A and 3B, an exemplary vehicle computing architecture 300 is shown. Vehicle computing architecture 300 may include a vehicle 305. A “vehicle,” for the purposes of this disclosure is a device that is designed to transport goods, people, and/or animals. In some embodiments, vehicle 305 may be consistent with vehicles as described throughout this disclosure.

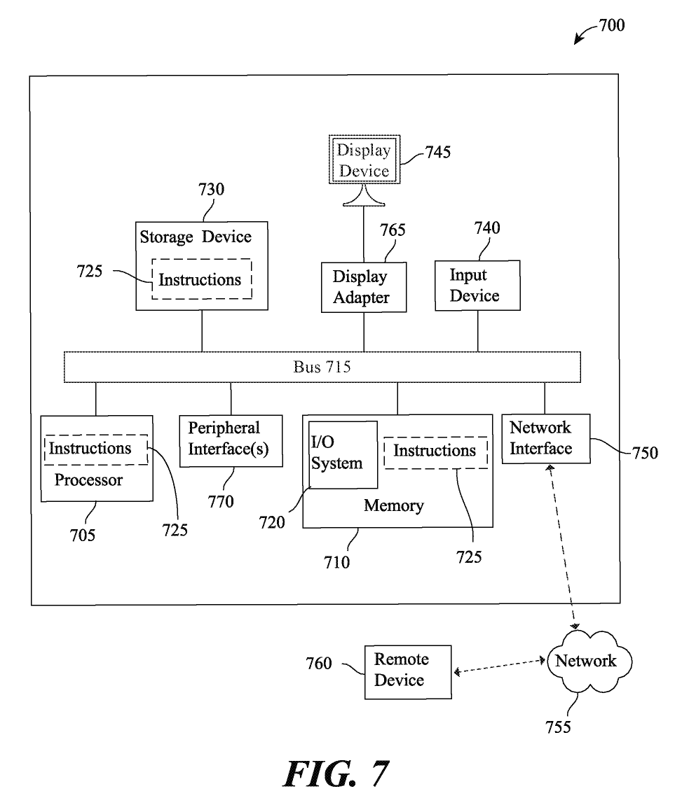

With continued reference to FIGS. 3A AND 3B, the vehicle 305 may be an autonomous vehicle that may drive, navigate, operate, etc. with minimal and/or no interaction from a human driver. Vehicle 305 may include a vehicle computing device 310 that implements a variety of systems on- board the vehicle 305. In some embodiments, vehicle computing device 310 may be consistent with aspects of computing device 700 described further with respect to FIG. 7.

With continued reference to FIGS. 3A and 3B, in some embodiments, vehicle computing architecture 300 may include one or more data acquisition systems 315. A data acquisition systems 315 may include a plurality of sensors configured to detect data from the environment surrounding or inside of vehicle 305. In some embodiments, data acquisition system 315 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 315 may include one or more LIDAR sensors. In some embodiments, data acquisition system 315 may include one or more ultrasound sensors. For example, ultrasound sensors may be mounted around the perimeter of vehicle 305. In some embodiments, ultrasound sensors may be located on the corners of vehicle 305. In some embodiments, ultrasound sensors may be used for object detection and/or collision avoidance. In some embodiments, data acquisition system 315 may include one or more microphones. In some embodiments, microphones may be arranged in an array. In some embodiments, microphones may include directional microphones. In some embodiments, microphones may include unidirectional microphones. In some embodiments data acquisition system 315 may include one or more RADAR sensors. In some embodiments, data acquisition system 315 may include, as non-limiting examples, lane detectors, optical readers, electric eyes, and/or other suitable types of image capture devices.

With continued reference to FIGS. 3A and 3B, vehicle computing device 310 may include a plurality of vehicle computing devices 310. As a non-limiting example, in some embodiments, vehicle computing device 310 may include, a central computing device and one or more auxiliary computing devices. In some embodiments, auxiliary computing devices may be located on or in the vehicle 305 roof. In some embodiments, auxiliary computing devices may be located close to certain sensors of data acquisition system 315 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 3A and 3B, the vehicle 305 may be configured to enter into a ready state. The ready state may indicate that the vehicle 305 is ready to operate (and/or return to) an autonomous navigation mode. A computing device on-board the vehicle 305 may be configured to determine whether the vehicle 305 is in the ready state. A remote computing device 320 (e.g., associated with an operations control center) may indicate that the vehicle 305 is ready to begin and/or resume autonomous navigation.

With continued reference to FIGS. 3A and 3B, for instance, the vehicle computing system 310 may include a communications system 325, one or more manual interface systems 330, one or more data acquisition systems 315, an autonomy command 335, one or more operational control components 340, and/or a manual control system 345.

With continued reference to FIGS. 3A and 3B, the manual interface systems 330 may be configured to allow interaction between a user (e.g., human) and the vehicle 305 (e.g., the vehicle computing system 310). The manual interface systems 330 may include a variety of interfaces for the user to input and/or receive information from the vehicle computing system 310. The manual interface systems 330 may include one or more input device(s) (e.g., touchscreens, keypad, touchpad, knobs, buttons, sliders, switches, mouse, gyroscope, microphone, other hardware interfaces) configured to receive user input. The manual interface systems 330 may include a user interface (e.g., graphical user interface, conversational and/or voice interfaces, chatter robot, gesture interface, other interface types) for receiving user input.

With continued reference to FIGS. 3A and 3B, vehicle computing system 310 may include a processor 350 and a memory 355. Processor 350 and memory 355 may be consistent with other processors and memory described throughout this disclosure. Processor 350 and memory 355 may be communicatively connected. Memory 355 may contain instructions (e.g., software) configured to cause processor 350 to perform one or more actions in accordance with this disclosure.

With continued reference to FIGS. 3A and 3B, vehicle computing architecture 300 may include a remote computing device 320. the remote computing device 320 may include and/or otherwise be associated with one or more computing devices (e.g., computing device 700, referred to in FIG. 7 that are remote from the vehicle 305. The remote computing device 320 may communicate with the vehicle 305 via one or more communications networks 360. The communications network 360 may include various wired and/or wireless communication mechanisms (e.g., cellular, wireless, satellite, microwave, and radio frequency) and/or any desired network topology. For example, the communications network 360 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 305.

### Exemplary Machine-Learning Module

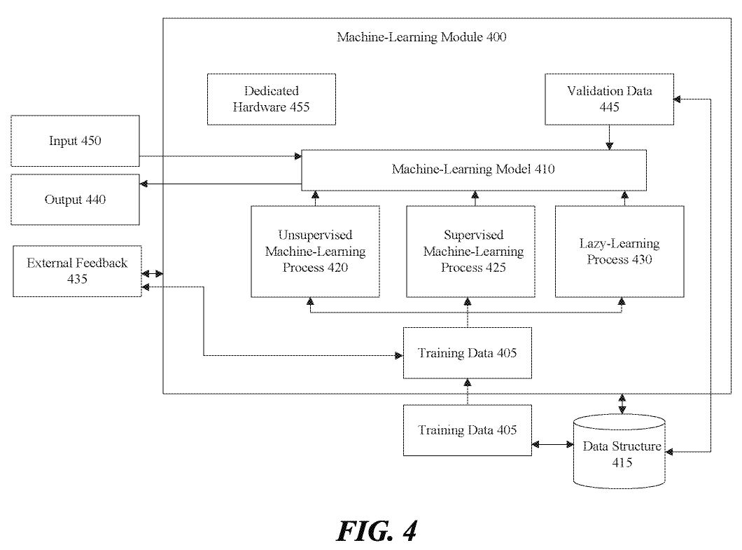

Referring now to FIG. 4, an exemplary embodiment of a machine-learning module 400 is shown. Machine-learning module 400 may be configured to perform one or more machine learning processes as described throughout this disclosure. Machine-learning module 400 may perform determinations, classification, and/or analysis steps, methods, processes, or the like as described in this disclosure using machine learning processes. A “machine learning process,” as used in this disclosure, is a process that automatedly uses training data 405 to generate one or more machine-learning models 410.

With continued reference to FIG. 4, for the purposes of this disclosure, “training data” is data that contains correlations that a machine-learning process may use to model relationships between two or more types of data. For example, training data 405 may include one or more training examples. Multiple data entries in training data 405 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. In some embodiments, training data 405 may include input training data correlated to output training data. Input training data may include, as a non-limiting example real-world data or features, as described further throughout this disclosure. Output training data may include, as a non-limiting example ground truth data (e.g., ground truth trajectories or intents) or calculated auxiliary features, as described further throughout this disclosure. Elements in training data 405 may be linked to descriptors of categories by tags, tokens, or other data elements; for instance, and without limitation, training data 405 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

With continued reference to FIG. 4, in some embodiments, training data 405 may be divided into different formats, categories, and/or groups. For example, in some embodiments, training data 405 may be divided into one or more cohorts, categorizations, time periods, data sources, and the like. In some embodiments, training data 405 may be assigned to categories using a classifier; as a non-limiting example, a training data classifier. Training data classifier may include a machine-learning module as described elsewhere with respect to FIG. 4. For example, in some embodiments, training data 405 may be input into training data classifier and training data classifier may output a classification. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 400 may generate a classifier using a classification algorithm, defined as a processes whereby a computing device and/or any module and/or component operating thereon derives a classifier from training data 405. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher’s linear discriminant, quadratic classifiers, decision trees, boosted trees, random forest classifiers, learning vector quantization, and/or neural network-based classifiers. In some embodiments, training data 405 may be classified into one or more categories such as geographical areas, sensor types, model numbers, weather, or time of day.

With continued reference to FIG. 4, training data 405 may be retrieved, in some embodiments, from a data structure 415. A data structure 415 may be remote to a computing device and communicative with a computing device by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure a computing device connect directly, dynamically, and non-hierarchically to as many other computing devices as possible. A “network topology” as used in this disclosure is an arrangement of elements of a communication network. data structure 415 may be implemented, without limitation, as a relational database, a key-value retrieval database such as a NOSQL database, or any other format or structure for use as a database that a person skilled in the art would recognize as suitable upon review of the entirety of this disclosure. data structure 415 may alternatively or additionally be implemented using a distributed data storage protocol and/or data structure, such as a distributed hash table or the like. data structure 415 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure. In an embodiment, data structure 415 may be a generic storage mechanism. A generic storage mechanism may be a storage system or method that is not specific to any particular type or format of data, that is, a storage solution that provides a flexible and adaptable way to store and retrieve data without being tied to a specific data format, schema, or domain. In some embodiments, training data 405 may be stored in data structure 415. In some embodiments, training data 405 may be retrieved from data structure 415.

With continued reference to FIG. 4, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

With continued reference to FIG. 4, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

With continued reference to FIG. 4, a “machine-learning model,” as used in this disclosure, is a data structure representing and/or instantiating a mathematical and/or algorithmic representation of a relationship between inputs and outputs as generated using any machine-learning process. For example, machine-learning process may include, without limitation, any machine-learning process described in this disclosure.

With continued reference to FIG. 4, machine-learning process may include an unsupervised machine-learning process 420. An unsupervised machine-learning process, as used herein, is a process that derives inferences in datasets without regard to labels; as a result, an unsupervised machine-learning process may be free to discover any structure, relationship, and/or correlation provided in the data. Unsupervised processes machine-learning process 420 may not require a response variable; unsupervised processes machine-learning process 420 may be used to find interesting patterns and/or inferences between variables, to determine a degree of correlation between two or more variables, or the like.

With continued reference to FIG. 4, machine-learning process may include a supervised machine-learning process 425. Supervised machine-learning process 425 may use training data 405 with both exemplary inputs and expected outputs and use that training data 405 to train a machine-learning model 410. For example, during a training process, machine learning process may evaluate an actual output generated by machine-learning model 410 and compare it to an expected output from training data 405. Based on the difference between the actual and expected outputs, one or more weights within machine-learning model 410 may be updated. For example, in some cases a scoring function may be used to train machine-learning model 410. Scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 405.

With continued reference to FIG. 4, machine-learning process may include a lazy-learning process 430. Lazy learning is a machine-learning approach in which the model delays generalization until a query is made. For example, this can be rather than learning a global model during training. Instead of building an abstract representation of the data up front, a lazy learner may store the training instances and wait until it needs to make a prediction. For example, when a new input arrives, the system may perform computation on the fly. Because no heavy training occurs in advance, lazy-learning algorithms may be fast to set up but can be computationally expensive at prediction time and often require storing large datasets in memory. An example may include k-nearest neighbors (k-NN), which classifies new points based on the labels of their closest neighbors in the stored data. Lazy learning may adapt naturally to new data because the “model” is effectively the dataset itself, but this also means it can be sensitive to noise and may not scale well with very large datasets.

With continued reference to FIG. 4, in some embodiments, machine-learning module 400 may receive external feedback 435. External feedback 435 may include, as a non-limiting example, feedback received from a user. In some embodiments, external feedback 435 may be received through a user interface (such as, for example, a graphical user interface (GUI).

With continued reference to FIG. 4, machine-learning module 400 may be configured to re-train machine-learning model 410. In some embodiments, re-training machine-learning model 410 may include re-training machine-learning model 410 as a function of external feedback 435. In some embodiments, external feedback 435 may serve as a source of labeled or partially labeled data that reflects how the model performs in real-world conditions. For example, if a user provides negative external feedback 435, then the set of data from training data 405 may be assigned a negative label. In some embodiments, external feedback 435 may include users correcting an output 440 of machine-learning model 410—such as flagging an incorrect prediction, choosing a preferred recommendation, or providing explicit labels. These interactions can be collected and added back into the training dataset. Over time, this additional data may help the model adapt to new patterns, correct systematic errors, and better align with user expectations. The re-training process may include cleaning and validating external feedback 435, merging it with existing datasets such as training data 405, and/or periodically running a new training cycle to update model parameters.

With continued reference to FIG. 4, machine-learning module 400 may be configured to validate machine-learning model 410. In some embodiments, machine-learning module 400 may validate machine-learning model 410 using validation data 445. Validation data 445 may be a subset of data used to train machine-learning model 405. For example, validation data 445 may include a subset of training data 405. In some embodiments, validation data 445 may include a percentage of training data 405. As non-limiting example, validation data 445 may include 1%,2%, 5%, 10%, 20%, 30%, and the like of training data 405. In some embodiments, machine-learning model 410 may not be exposed to validation data 445 during training. Validation data 445 may acts as a checkpoint that helps determine whether the model is generalizing well or simply memorizing training data 405. As the model learns, its performance on the validation set may be monitored to guide decisions such as choosing hyperparameters, selecting architectures, adjusting regularization strength, or determining when to stop training to avoid overfitting.

With continued reference to FIG. 4, machine-learning model 410 may be configured to receive one or more inputs 450 and generate, as a function of the one or more inputs 450, one or more outputs 440. Outputs 440 may be presented to users for example trough user interfaces and/or GUIs. In some embodiments, external feedback 435 may be received users as a function of output 440.

With continued reference to FIG. 4, one or more, processes, machine-learning processes, actions, steps, or the like as disclosed above may be performed using dedicated hardware 455. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware 455 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware 455 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware 455 to perform one or more operations described herein, such as evaluation of model and/or algorithm outputs, one-time or iterative updates to parameters, coefficients, weights, and/or biases, and/or any other operations such as vector and/or matrix operations as described in this disclosure.

### Exemplary Neural Network

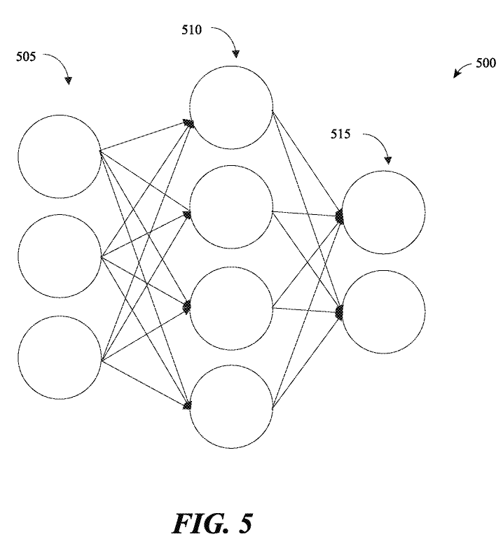

Referring now to FIG. 5, an exemplary embodiment of neural network 500 is illustrated. A neural network 500 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 505, one or more intermediate layers 510, and an output layer of nodes 515. Connections between nodes may be created using a process of "training" the network, in which elements from a training dataset may applied to the input nodes. A suitable training algorithm (such as Levenberg-Marquardt, conjugate gradient, simulated annealing, or other algorithms) may then be used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

### Exemplary Method for Improved Road Agent Behavior Prediction Using Multi-Task Learning

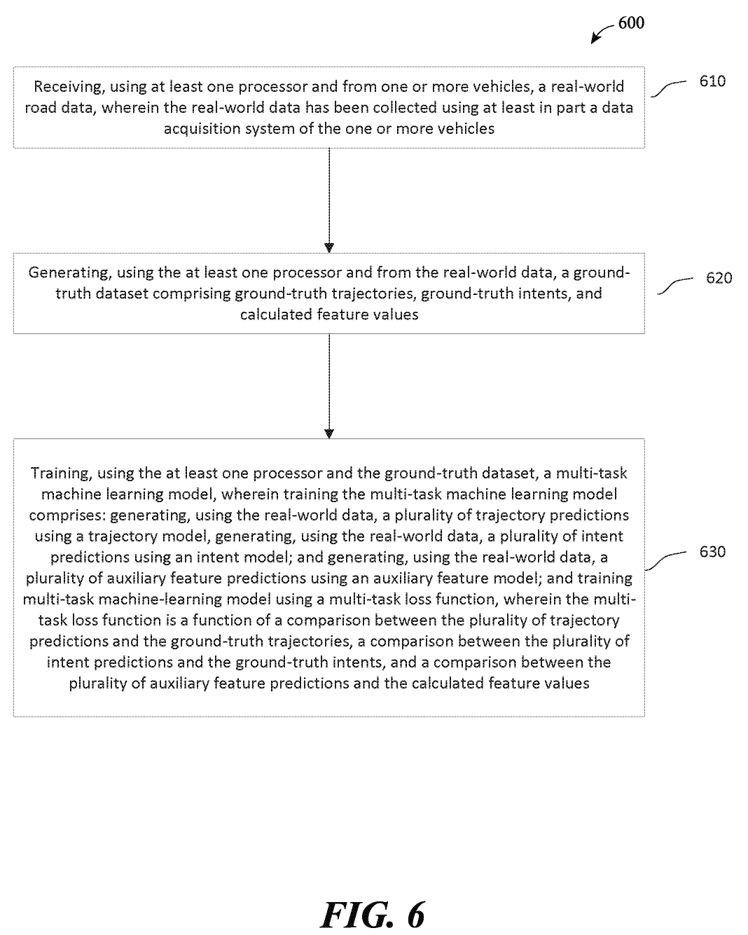

Referring now to FIG. 6, an exemplary method 600 for improved road agent behavior prediction using multi-task learning is shown. The method includes a step 610 of receiving, using at least one processor and from one or more vehicles, a real-world road data, wherein the real-world data has been collected using at least in part a data acquisition system of the one or more vehicles. This may be conducted, in a non-limiting manner, as disclosed with reference to FIGS. 1A-5.

With continued reference to FIG. 6, method 600 includes a step 620 of generating, using the at least one processor and from the real-world data, a ground-truth dataset including ground-truth trajectories, ground-truth intents, and calculated feature values. This may be conducted, in a non-limiting manner, as disclosed with reference to FIGS. 1A-5.

With continued reference to FIG. 6, method 600 includes a step 630 of training, using the at least one processor and the ground-truth dataset, a multi-task machine learning model, wherein training the multi-task machine learning model includes: generating, using the real-world data, a plurality of trajectory predictions using a trajectory model; generating, using the real-world data, a plurality of intent predictions using an intent model; and generating, using the real-world data, a plurality of auxiliary feature predictions using an auxiliary feature model; and training multi-task machine-learning model using a multi-task loss function, wherein the multi-task loss function is a function of a comparison between the plurality of trajectory predictions and the ground-truth trajectories, a comparison between the plurality of intent predictions and the ground-truth intents, and a comparison between the plurality of auxiliary feature predictions and the calculated feature values. This may be conducted, in a non-limiting manner, as disclosed with reference to FIGS. 1A-5.

With continued reference to FIG. 6, in some aspects, the techniques described herein relate to a method, wherein generating the ground-truth dataset includes generating, from the real-world data, ground-truth trajectories, wherein generating, from the real-world data, the ground-truth trajectories includes tacking a location of an agent through a temporal period to determine a ground-truth trajectory associated with the agent. This may be conducted, in a non-limiting manner, as disclosed with reference to FIGS. 1A-5.

With continued reference to FIG. 6, in some aspects, the techniques described herein relate to a method, wherein generating the ground-truth dataset includes generating, from the real-world data, ground-truth intents, wherein generating, from the real-world data, the ground-truth intents includes determining an action for an agent. This may be conducted, in a non-limiting manner, as disclosed with reference to FIGS. 1A-5.

With continued reference to FIG. 6, in some aspects, the techniques described herein relate to a method, wherein generating the ground-truth dataset includes calculating, from the real-world data, calculated feature values, wherein calculating, from the real-world data, the calculated feature values includes: identifying an auxiliary feature in the real-world data, wherein the auxiliary feature corresponds with a real-world object; and calculating a distance between the auxiliary feature and an agent. This may be conducted, in a non-limiting manner, as disclosed with reference to FIGS. 1A-5.

With continued reference to FIG. 6, in some aspects, the techniques described herein relate to a method, further including: receiving, using the at least one processor, a deployment dataset from a data acquisition system of the one or more vehicles; and extracting, using the at least one processor, a plurality of features, from the deployment dataset, into a shared feature space using a feature-extraction backbone. This may be conducted, in a non-limiting manner, as disclosed with reference to FIGS. 1A-5.

With continued reference to FIG. 6, in some aspects, the techniques described herein relate to a method, further including determining, using the at least one processor, a trajectory determination from the plurality of extracted features using the trained trajectory model. This may be conducted, in a non-limiting manner, as disclosed with reference to FIGS. 1A-5.

With continued reference to FIG. 6, in some aspects, the techniques described herein relate to a method, further including determining, using the at least one processor, an intent determination from the plurality of extracted features using the trained intent model. This may be conducted, in a non-limiting manner, as disclosed with reference to FIGS. 1A-5.

With continued reference to FIG. 6, in some aspects, the techniques described herein relate to a method, wherein the deployment dataset includes visual data and depth data. This may be conducted, in a non-limiting manner, as disclosed with reference to FIGS. 1A-5.

With continued reference to FIG. 6, in some aspects, the techniques described herein relate to a method, further including decoupling, using the at least a processor, the auxiliary feature model from the multi-task machine learning model after the multi-task machine learning model has been trained. This may be conducted, in a non-limiting manner, as disclosed with reference to FIGS. 1A-5.

With continued reference to FIG. 6, in some aspects, the techniques described herein relate to a method, wherein the one or more vehicles includes a car. This may be conducted, in a non-limiting manner, as disclosed with reference to FIGS. 1A-5.

### Exemplary Computing Device

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 705 and a memory 710 that communicate with each other, and with other components, via a bus 715. Bus 715 may include any of several types of bus structures including, but not limited to, a memory bus, a memory controller, a peripheral bus, a local bus, and any combinations thereof, using any of a variety of bus architectures.

Processor 705 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 705 may be organized according to Von Neumann and/or Harvard architecture as a non-limiting example. Processor 705 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo’s algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 710 may include various components (e.g., machine-readable media) including, but not limited to, a random-access memory component, a read only component, and any combinations thereof. In one example, a basic input/output system 720 (BIOS), including basic routines that help to transfer information between elements within computer system 700, such as during start-up, may be stored in memory 710. Memory 710 may also include (e.g., stored on one or more machine-readable media) instructions (e.g., software) 725 embodying any one or more of the aspects and/or methodologies of the present disclosure. In another example, memory 710 may further include any number of program modules including, but not limited to, an operating system, one or more application programs, other program modules, program data, and any combinations thereof. Memory 710 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 700 may also include a storage device 730. Examples of a storage device (e.g., storage device 730) include, but are not limited to, a hard disk drive, a magnetic disk drive, an optical disc drive in combination with an optical medium, a solid-state memory device, and any combinations thereof. Storage device 730 may be connected to bus 715 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 730 (or one or more components thereof) may be removably interfaced with computer system 700 (e.g., via an external port connector (not shown)). Particularly, storage device 730 and an associated machine-readable medium may provide nonvolatile and/or volatile storage of machine-readable instructions, data structures, program modules, and/or other data for computer system 700. In some embodiments, storage device 730 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 725) may reside, completely or partially, within machine-readable medium . In another example, software may reside, completely or partially, within processor 705.

Computer system 700 may also include an input device 740. In one example, a user of computer system 700 may enter commands and/or other information into computer system 700 via input device 740. Examples of an input device 740 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 740 may be interfaced to bus 715 via any of a variety of interfaces (not shown) including, but not limited to, a serial interface, a parallel interface, a game port, a USB interface, a FIREWIRE interface, a direct interface to bus 715, and any combinations thereof. Input device 740 may include a touch screen interface that may be a part of or separate from display 745, discussed further below. Input device 740 may be utilized as a user selection device for selecting one or more graphical representations in a graphical interface as described above.

A user may also input commands and/or other information to computer system 700 via storage device 730 (e.g., a removable disk drive, a flash drive, etc.) and/or network interface device 750. A network interface device, such as network interface device 750, may be utilized for connecting computer system 700 to one or more of a variety of networks, such as network 755, and one or more remote devices 760 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data neitwork associated with a telephone/voice provider (e.g., a mobile communications provider data and/or voice network), a direct connection between two computing devices, and any combinations thereof. A network, such as network 755, may employ a wired and/or a wireless mode of communication. In general, any network topology may be used. Information (e.g., data, software, etc.) may be communicated to and/or from computer system 700 via network interface device 750.

Computer system 700 may further include a video display adapter 765 for communicating a displayable image to a display device, such as display 745. Examples of a display device include, but are not limited to, a liquid crystal display (LCD), a cathode ray tube (CRT), a plasma display, a light emitting diode (LED) display, and any combinations thereof. Display adapter 765 and display 745 may be utilized in combination with processor 705 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 715 via a peripheral interface 770. Examples of a peripheral interface include, but are not limited to, a serial port, a USB connection, a FIREWIRE connection, a parallel connection, and any combinations thereof.

Further referring to FIG. 7, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 7, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 7, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 700, processor 705, and memory 710 may be virtualized; that is, a virtual machine and/or container may interact directly with such computing system 700, processor 705, and/or memory 710, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 705 comprises a plurality of processors and/or processor cores, virtualization may, in some cases, simulate or emulate a single (virtual) processor whose functions are allocated to one or more of the plurality of processors and/or processor cores. In this case, while processor 705 may be said to be virtualized, the processor 705, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular the methods and apparatus used to implement the disclosure may be modified without changing the spirit of the invention, and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. An apparatus for improved road agent behavior prediction using multi-task learning, the apparatus comprising:
at least one processor; and
a memory, wherein the memory is communicatively connected to the at least one processor, the memory contains instructions configuring the at least one processor to:
receive, from one or more vehicles, a real-world road data, wherein the real-world data has been collected using at least in part a data acquisition system of the one or more vehicles;
generate, from the real-world data, a ground-truth dataset comprising ground-truth trajectories, ground-truth intents, and calculated feature values; and
train, using the ground-truth dataset, a multi-task machine learning model, wherein training the multi-task machine learning model comprises:
generating, using the real-world data, a plurality of trajectory predictions using a trajectory model;
generating, using the real-world data, a plurality of intent predictions using an intent model; and
generating, using the real-world data, a plurality of auxiliary feature predictions using an auxiliary feature model; and
training multi-task machine-learning model using a multi-task loss function, wherein the multi-task loss function is a function of a comparison between the plurality of trajectory predictions and the ground-truth trajectories, a comparison between the plurality of intent predictions and the ground-truth intents, and a comparison between the plurality of auxiliary feature predictions and the calculated feature values.

2. The apparatus of claim 1, wherein generating the ground-truth dataset comprises generating, from the real-world data, ground-truth trajectories, wherein generating, from the real-world data, the ground-truth trajectories comprises tacking a location of an agent through a temporal period to determine a ground-truth trajectory associated with the agent.

3. The apparatus of claim 1, wherein generating the ground-truth dataset comprises generating, from the real-world data, ground-truth intents, wherein generating, from the real-world data, the ground-truth intents comprises determining an action for an agent.

4. The apparatus of claim 1, wherein generating the ground-truth dataset comprises calculating, from the real-world data, calculated feature values, wherein calculating, from the real-world data, the calculated feature values comprises:
identifying an auxiliary feature in the real-world data, wherein the auxiliary feature corresponds with a real-world object; and
calculating a distance between the auxiliary feature and an agent.

5. The apparatus of claim 1, wherein the memory contains instructions further configuring the at least a processor to:
receive a deployment dataset from a data acquisition system of the one or more vehicles; and
extract a plurality of features, from the deployment dataset, into a shared feature space using a feature-extraction backbone.

6. The apparatus of claim 5, wherein the memory contains instructions further configuring the at least a processor to determine a trajectory determination from the plurality of extracted features using the trained trajectory model.

7. The apparatus of claim 5, wherein the memory contains instructions further configuring the at least a processor to determine an intent determination from the plurality of extracted features using the trained intent model.

8. The apparatus of claim 5, wherein the deployment dataset comprises visual data and depth data.

9. The apparatus of claim 1, wherein the memory contains instructions further configuring the at least a processor to decouple the auxiliary feature model from the multi-task machine learning model after the multi-task machine learning model has been trained.

10. The apparatus of claim 1, wherein the one or more vehicles comprises a car.

11. An method for improved road agent behavior prediction using multi-task learning, the method comprising:
receiving, using at least one processor and from one or more vehicles, a real-world road data, wherein the real-world data has been collected using at least in part a data acquisition system of the one or more vehicles;
generating, using the at least one processor and from the real-world data, a ground-truth dataset comprising ground-truth trajectories, ground-truth intents, and calculated feature values; and
training, using the at least one processor and the ground-truth dataset, a multi-task machine learning model, wherein training the multi-task machine learning model comprises:
generating, using the real-world data, a plurality of trajectory predictions using a trajectory model;
generating, using the real-world data, a plurality of intent predictions using an intent model; and
generating, using the real-world data, a plurality of auxiliary feature predictions using an auxiliary feature model; and
training multi-task machine-learning model using a multi-task loss function, wherein the multi-task loss function is a function of a comparison between the plurality of trajectory predictions and the ground-truth trajectories, a comparison between the plurality of intent predictions and the ground-truth intents, and a comparison between the plurality of auxiliary feature predictions and the calculated feature values.

12. The method of claim 11, wherein generating the ground-truth dataset comprises generating, from the real-world data, ground-truth trajectories, wherein generating, from the real-world data, the ground-truth trajectories comprises tacking a location of an agent through a temporal period to determine a ground-truth trajectory associated with the agent.

13. The method of claim 11, wherein generating the ground-truth dataset comprises generating, from the real-world data, ground-truth intents, wherein generating, from the real-world data, the ground-truth intents comprises determining an action for an agent.

14. The method of claim 11, wherein generating the ground-truth dataset comprises calculating, from the real-world data, calculated feature values, wherein calculating, from the real-world data, the calculated feature values comprises:
identifying an auxiliary feature in the real-world data, wherein the auxiliary feature corresponds with a real-world object; and
calculating a distance between the auxiliary feature and an agent.

15. The method of claim 11, further comprising:
receiving, using the at least one processor, a deployment dataset from a data acquisition system of the one or more vehicles; and
extracting, using the at least one processor, a plurality of features, from the deployment dataset, into a shared feature space using a feature-extraction backbone.

16. The method of claim 15, further comprising determining, using the at least one processor, a trajectory determination from the plurality of extracted features using the trained trajectory model.

17. The method of claim 15, further comprising determining, using the at least one processor, an intent determination from the plurality of extracted features using the trained intent model.

18. The method of claim 15, wherein the deployment dataset comprises visual data and depth data.

19. The method of claim 11, further comprising decoupling, using the at least a processor, the auxiliary feature model from the multi-task machine learning model after the multi-task machine learning model has been trained.

20. The method of claim 11, wherein the one or more vehicles comprises a car.
